(19) United States
(12) Patent Application Publication
(10) Pub. No.: US 2014/0008332 A1
(43) Pub. Date: Jan. 9, 2014

(54) METHOD AND SYSTEM OF USING GAS FLOW TO CONTROL WELD PUDDLE IN OUT-OF-POSITION WELDING

(71) Applicant: LINCOLN GLOBAL, INC., City of Industry, CA (US)

(72) Inventors: Jonathan S. OGBORN, Concord Twp., OH (US); Edward Enyedy, Eastlake, OH (US); Steven R. Sumner, Brunswick, OH (US)

(21) Appl. No.: 13/788,688

(22) Filed: Mar. 7, 2013

Related U.S. Application Data
(60) Provisional application No. 61/668,828, filed on Jul. 6, 2012.

(51) Int. Cl. B23K 26/20; B23K 26/14

(52) U.S. Cl. CPC B23K 26/203; B23K 26/14
USPC 219/121.63; 219/137.62; 219/121.84

(57) ABSTRACT

A system and method for using gas flow to control a molten puddle in out-of-position applications is provided. The system includes a high intensity energy source configured to heat at lease one workpiece to create a molten puddle and a housing assembly configured to supply a gas over the molten puddle in order to minimize sagging of the molten puddle in the out-of-position applications. The system also includes a gas source that is configured to supply the gas. The gas source is operatively connected to the housing assembly. The pressure of the gas in the housing assembly is in a range of 15 psi to 35 psi. The method includes heating at least one workpiece to create a molten puddle and supplying a gas over the molten puddle via a housing assembly in order to minimize sagging of the molten puddle in the out-of-position applications.

### PRIORITY

The present application claims priority to U.S. Provisional Patent Application No. 61/668,828, which is incorporated herein by reference in its entirety.

### TECHNICAL FIELD

Certain embodiments relate to controlling a weld puddle in welding applications. More particularly, certain embodiments relate to a system and method of using gas flow to control a weld puddle in out-of-position welding in arc-less welding applications.

### BACKGROUND

In many types of traditional welding, a molten puddle (or weld puddle) is formed in a joint of a workpiece using a high energy heat source and filler material is deposited into the weld puddle. For example as shown in FIG. 1, in a gas-tungsten arc welding (GTAW) filler wire method, a high energy heat source such as a power supply 70 with a tungsten electrode 75 may be used to create an arc 10 between the electrode 75 and workpiece 15. The arc creates a weld puddle 45 in a joint of the workpiece 15. Inert gas 85 from gas supply 80 provides a “shielding gas” around the arc 10 and weld puddle 45 to prevent contamination of the weld from the oxygen and nitrogen present in the atmosphere. The inert gas may be helium, argon or a mixture of the two. A filler wire 40, which may be heated, is deposited into the weld puddle 45. Once cooled, the filler material and the metal from the workpiece 15 form a sound joint.

When the workpiece is positioned flat as shown in FIG. 1, gravity helps to control the weld puddle 45. That is, the weld puddle stays in the joint of the workpiece. However, when the workpiece is oriented differently as shown in FIGS. 2A-2C, the weld puddle can sag or spill out of the joint due to gravity. Traditionally, various techniques have been employed to manage the molten weld puddle. These techniques include selecting electrodes and flux coverings that will quickly form slag on the weld and creating a shallower weld puddle, as well as controlling the arc current to control the puddle.

In addition, with respect to arc welding, it is known that the force of the arc itself can help manage the weld puddle by keeping the puddle in place. However, not all welding methods create a weld puddle by creating an arc. For example, in some welding systems, the high energy heat source that creates the weld puddle may be a laser and a hot-wire method can be used to add the filler wire. In such systems, arcing is to be avoided as it would be detrimental to the welding process. Accordingly, while some of the out-of-position techniques can be employed in arc-less welding such as laser welding, there is a greater potential for the weld puddle to sag or spill out of the joint when using such arc-less welding methods.

Further limitations and disadvantages of conventional, traditional, and proposed approaches will become apparent to one of skill in the art, through comparison of such approaches with embodiments of the present invention as set forth in the remainder of the present application with reference to the drawings.

### SUMMARY

Embodiments of the present invention comprise a system and method to use a laser and hot-wire welding method when welding out-of-position to keep the weld puddle in place. Exemplary embodiments include a system and method for performing any of brazing, cladding, building up, filling, hard-facing overlaying, and joining/welding in out-of-position applications. In some embodiments, the system includes a high intensity energy source configured to heat at least one workpiece to create a molten puddle and a housing assembly configured to supply a gas over the molten puddle in order to minimize sagging of the molten puddle in the out-of-position applications. The system also includes a gas source that is configured to supply the gas. The gas source is operatively connected to the housing assembly. The pressure of the gas in the housing assembly is in a range of 15 psi to 35 psi. The method includes heating at least one workpiece to create a molten puddle and supplying a gas via a housing assembly over the molten puddle in order to minimize sagging of the molten puddle in the out-of-position applications.

These and other features of the claimed invention, as well as details of illustrated embodiments thereof, will be more fully understood from the following description and drawings.

### BRIEF DESCRIPTION OF THE DRAWINGS

The above and/or other aspects of the invention will be more apparent by describing in detail exemplary embodiments of the invention with reference to the accompanying drawings, in which:

FIG. 1 illustrates a diagrammatical representation of a GTAW welding system;

FIG. 2A-2C illustrates exemplary out-of-position welding;

FIG. 3 illustrates a diagrammatical representation of an exemplary embodiment of the present invention;

FIGS. 4A-4C illustrates various exemplary embodiments of a gas delivery configuration in accordance with the present invention;

FIG. 5 illustrates a diagrammatical representation of a welding operation with an embodiment of the present invention; and

FIG. 6 illustrates a diagrammatical representation of an additional welding operation with an exemplary embodiment of the present invention.

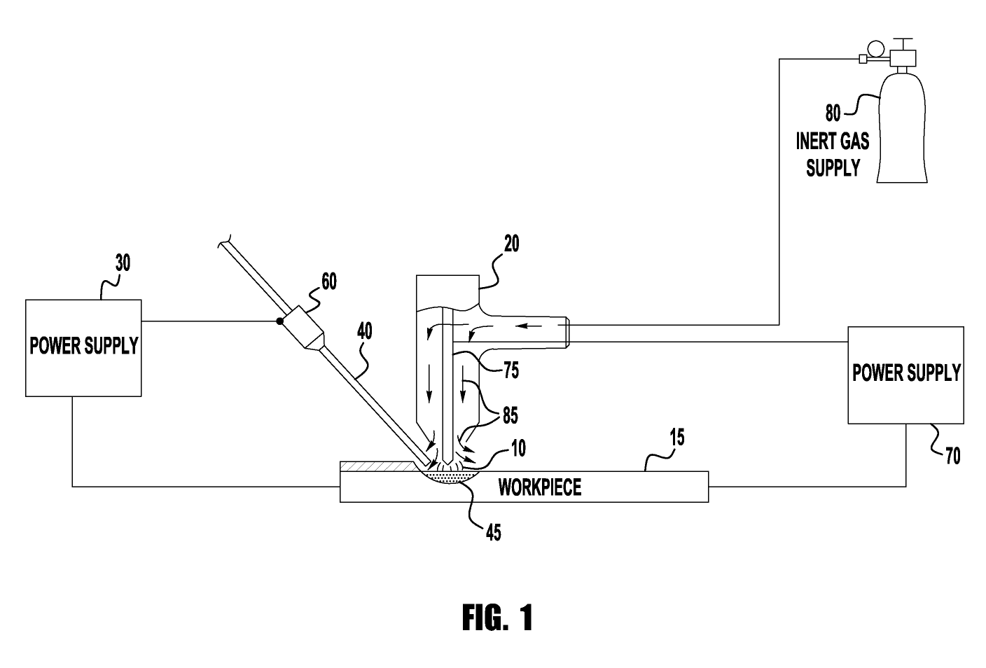

### DETAILED DESCRIPTION

Exemplary embodiments of the invention will now be described below by reference to the attached Figures. The described exemplary embodiments are intended to assist the understanding of the invention, and are not intended to limit the scope of the invention in any way. Like reference numerals refer to like elements throughout.

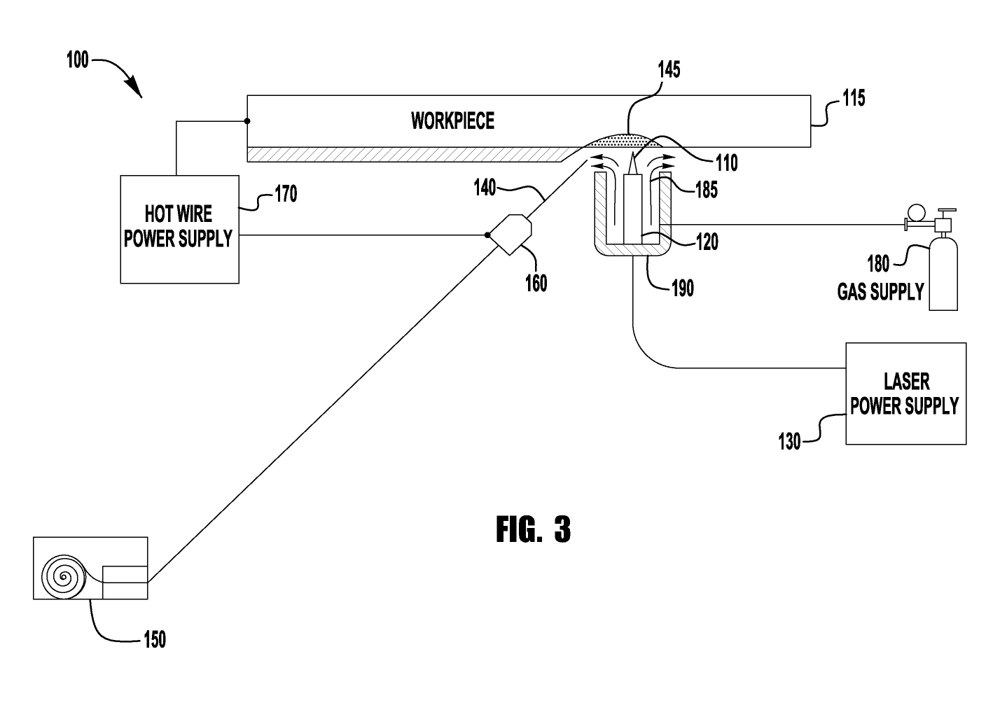

FIG. 3 illustrates a functional schematic block diagram of an exemplary embodiment of a combination filler wire feeder and energy source system 100 for performing any of brazing, cladding, building up, filling, hard-facing overlaying, and joining/welding applications. The system 100 includes a laser subsystem 120/130 capable of focusing a laser beam 110 onto a workpiece 115 to heat and create a molten puddle (i.e., weld puddle) 145 in workpiece 115. The laser subsystem is a high intensity energy source. The laser subsystem 120/130 can be any type of high energy laser source, including but not limited to carbon dioxide, Nd:YAG, Yb-disk, YB-fiber, fiber delivered or direct diode laser systems. Further, even white light or quartz laser type systems can be used if they have sufficient energy. For example, a high intensity energy source can provide at least 500 W/cm². The laser subsystem includes a laser device 120 and a laser power supply 130 operatively connected to each other. The laser power supply 130 provides power to operate the laser device 120.

The system 100 also includes a hot filler wire feeder subsystem capable of providing at least one resistive filler wire 140 to make contact with the workpiece 115 in the vicinity of the laser beam 110. Of course, it is understood that by reference to the workpiece 115 herein, the weld puddle 145 is considered part of the workpiece 115, thus reference to contact with the workpiece 115 includes contact with the puddle 145. The hot filler wire feeder subsystem includes a filler wire feeder 150, a contact tube 160, and a hot wire power supply 170. During operation, the filler wire 140, which leads the laser beam 110, is resistance-heated by electrical current from the hot wire welding power supply 170 which is operatively connected between the contact tube 160 and the workpiece 115. In other exemplary embodiments, different heating methods can be used, such as inductance heating. In accordance with an embodiment of the present invention, the hot wire welding power supply 170 is a pulsed direct current (DC) power supply, although alternating current (AC) or other types of power supplies are possible as well. The wire 140 is fed from the filler wire feeder 150 through the contact tube 160 toward the workpiece 115 and extends beyond the tube 160. The extension portion of the wire 140 is resistance-heated such that the extension portion approaches or reaches the melting point before contacting a weld puddle on the workpiece. The laser beam 110 serves to melt some of the base metal of the workpiece 115 to form the weld puddle 145 and also to melt the wire 140 onto the workpiece 115. The power supply 170 provides a large portion of the energy needed to resistance-melt the filler wire 140. However, the output from power supply 170 is controlled such that an arc is not created between wire 140 and workpiece 115, thus preventing any undesired effects such as splatter or burn-through from occurring. That is, the heating current and/or output voltage are controlled such that arcing is substantially eliminated or minimized. The feeder subsystem 150 may be capable of simultaneously providing one or more wires (not illustrated), in accordance with certain other embodiments of the present invention. For example, a first wire may be used for hard-facing and/or providing corrosion resistance to the workpiece, and a second wire may be used to add structure to the workpiece.

As shown in FIG. 3, the workpiece 115 is in an overhead position. As such, there is a potential for the weld puddle 145 to sag or spill out of the joint due to gravity. In traditional arc welding methods, the force of the arc helped in managing the weld puddle. However, in the exemplary embodiment, the weld puddle is formed without creating an arc. While techniques such as selecting the appropriate filler wire and controlling the depth of the weld by adjusting the output of laser 120 may help, there is still a greater potential for sagging and spillage of the weld puddle in arc-less welding. Accordingly, consistent with the present invention, gas 185, which is regulated and supplied from gas supply 180, is forced over the surface of the weld puddle 145 to eliminate or lessen any sagging and to help keep the weld puddle 145 from spilling out of the joint.

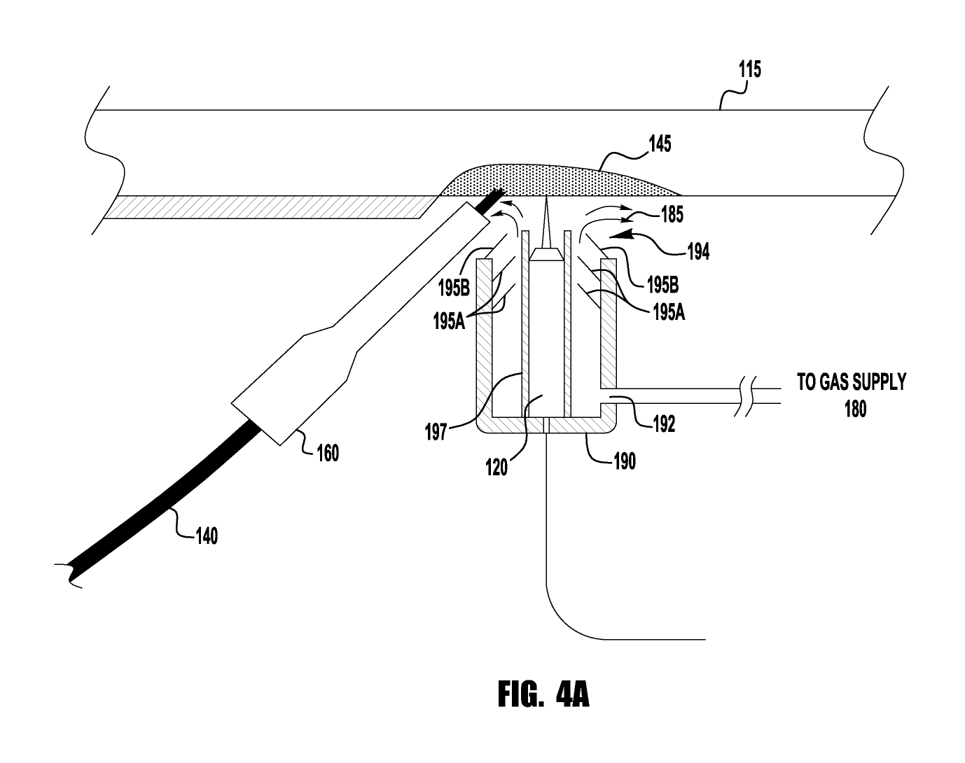

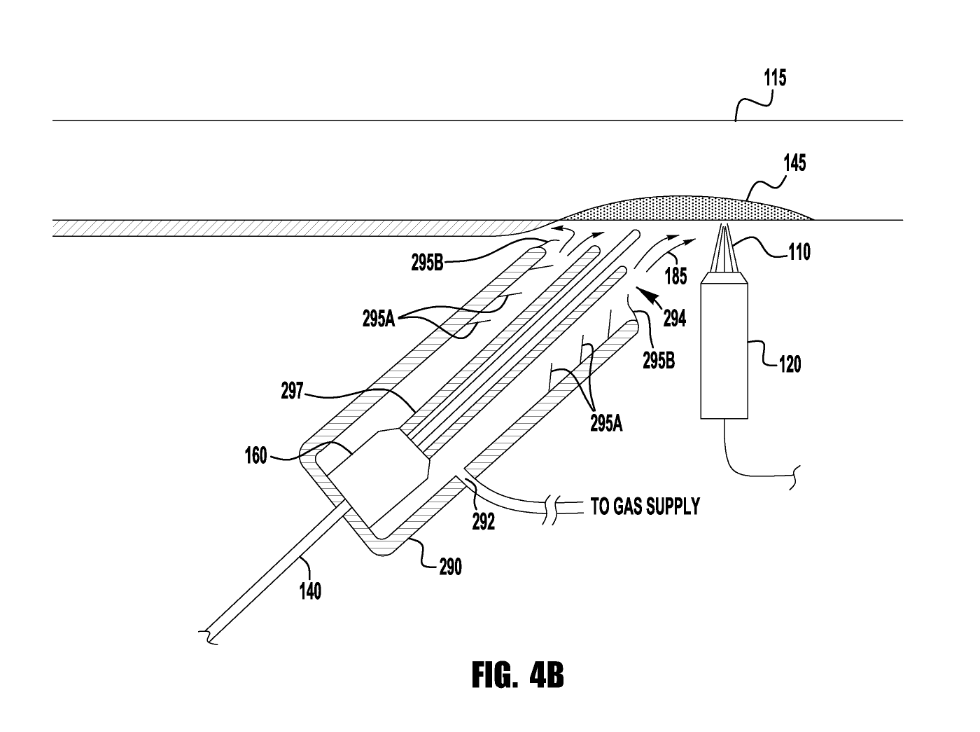

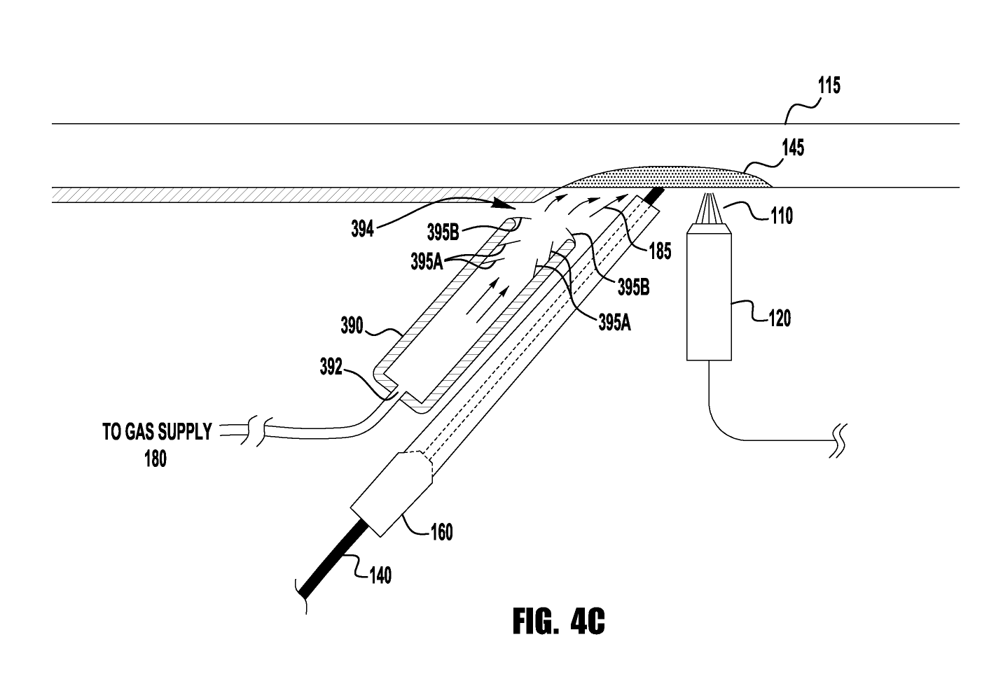

As illustrated in FIG. 3, the gas 185 is introduced into housing assembly 190. A cross-sectional view of housing assembly 190 is illustrated in FIG. 4A. Gas 185 may be introduced into housing assembly 190 via opening 192. Laser 120 may be located inside housing assembly 190. Alternatively, laser 120 may be located outside gas assembly 190 (not shown) and only laser beam 110 is sent through gas assembly 190 using appropriate optics. In exemplary embodiments, during welding operations, gas 185 is forced through the opening 194 formed between housing assembly 190 and workpiece 115. In some embodiments, the housing assembly 190 includes guide vanes 195A and B, which can be adjusted such that more or less gas flow can be directed to the leading or trailing edge of the weld puddle 145. Guide vanes 195A may be located in the interior of housing assembly 190. In addition to guide vanes 195A (or in the alternative), guide vanes 195B may be located at the tip of housing assembly 190 to direct the flow of gas 185 across weld puddle 145. In a non-limiting embodiment, gas 185 is isolated from the path of laser beam 110 by tube 197 to prevent any undesired heating or interactions. The contact tube 160 is of a construction which can facilitate the heating of the wire 140, whether through resistance or inductive heating, and to guide the wire to the puddle 145. However, the tube 160 is to have a configuration such that it shrouds or protects the wire 140 from the gas during operation. As it is known, during hot wire welding the wire 140 is heated near its welding temperature to be melted in the puddle. However, if the gas 185 were permitted to significantly contact the wire 140 before it enters the puddle 145 the gas 185 could cool the wire 140 and thus interfere with the hot wire process. Thus, the tube 160 is configured to provide maximum shielding for the wire 140 as it is delivered to the puddle.

FIG. 4B illustrates an exemplary embodiment of a housing assembly 290 which can shield the tube 160 and deliver the gas 185 to the puddle 145. In this embodiment, housing assembly 290 surrounds contact tube 160 and introduces the gas 185 in the trailing end of the weld puddle 145. As discussed above, in some embodiments the filler wire 140 is resistance-heated to (or just under) it's melting temperature by power supply 170 (see FIG. 3). To prevent undesired cooling, the heated filler wire 140 is isolated from gas 185 by an insulating sheath 297. Similar to the embodiment discussed above, housing assembly 290 may include guide vanes 295A and B to control the flow of gas 185 to the leading and trailing edges of weld puddle 145 through an opening 294 formed between housing assembly 290 and workpiece 115. The sheath 297 is of a length and configuration to prevent unwanted cooling of the wire 140 during operation. Thus, in some exemplary embodiments the sheath 297 is configured such that during operation the gap between the edge of the sheath 297 and the weld puddle 145 is no more than 0.125 inches.

FIG. 4C illustrates another exemplary embodiment of the present invention, where the housing assembly 390 is separate from the laser and the tube 160. In this embodiment, housing assembly 390 does not include either laser 120 or contact tube 160. Gas 185 is introduced to housing assembly 390 through opening 392. Housing assembly 390 is located at the trailing edge of weld puddle 145 and directs the flow of gas 185 over weld puddle 145 through an opening 394 formed between housing assembly 390 and workpiece 115. Similar to the above embodiments, guide vanes 395A and B control the direction of gas flow to the leading and trailing edges of weld puddle 145. Alternatively, housing assembly 390 may be located at the leading edge of the weld puddle 145. Again, the tube 160 is to have a configuration which shields the wire 140 from the majority of the gas flow during operation to prevent any unnecessary cooling.

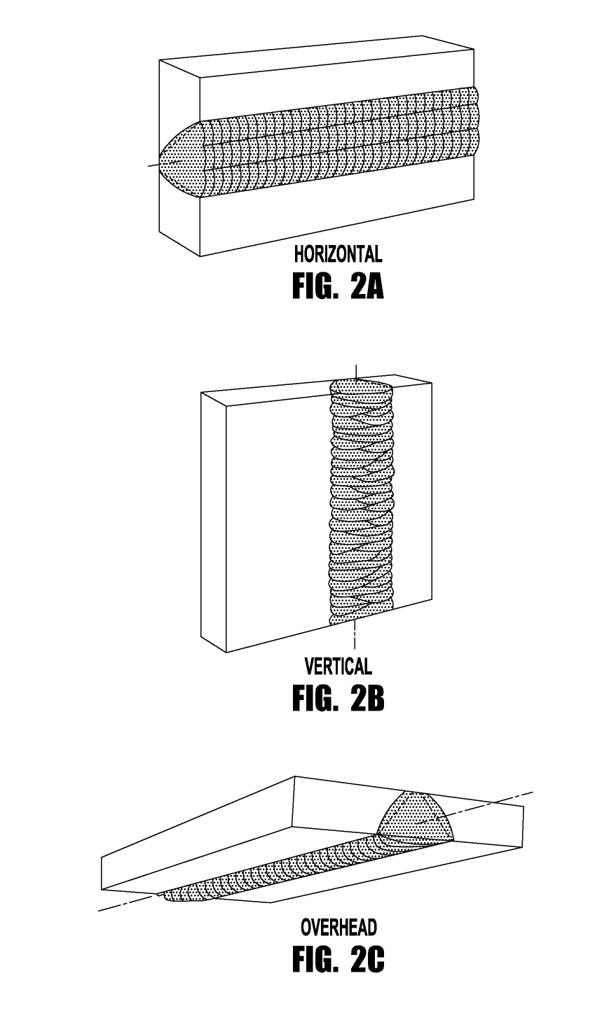

The above discussed figures depict an overhead welding position. However, the discussed embodiments can be used in horizontal and vertical out-of-position welding (see FIGS. 2A and 2B). In a non-limiting embodiment, for horizontal and vertical out-of-position welding, the guide vanes in each embodiment are positioned such that gas 185 flows in a generally upward direction (i.e., opposite the direction of gravity) across weld puddle 145. That is the vanes can be oriented in a direction that directs the gas 185 in the desired direction. This can be accomplished a number of different ways. For example, the vanes can be moveable by a user to orient them as desired, or the housings to which the vanes are attached can be rotatable such that the rotation of the housing can be used to orient the vanes in an appropriate direction.

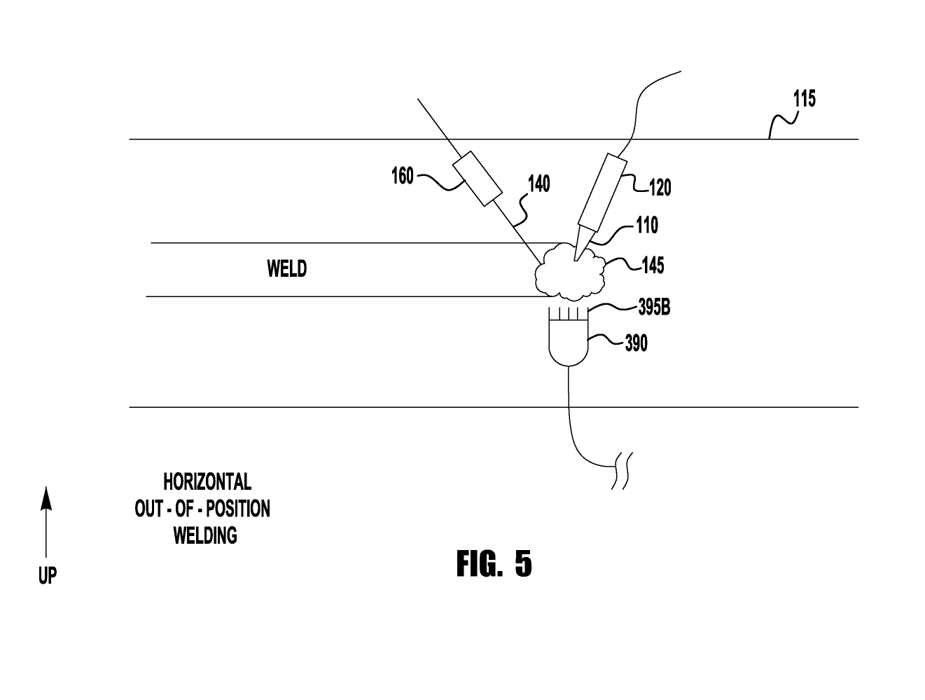

In a non-limiting embodiment, housing assembly 390 need not be in-line with filler wire 140 and laser 120. Instead, housing assembly 390 may be located at an angle to wire 140 and laser 120. FIG. 5 illustrates a horizontal out-of-position weld. Here, laser 120 forms weld puddle 145 and filler wire 140 is inserted into the trailing end of weld puddle 145. Filler wire 140 and laser 120 are in-line with respect to the joint being welded. Housing assembly 390 is located below the weld puddle 145 and gas 185 (not shown) flows in a generally upward direction in order to help prevent the weld puddle 145 from sagging or spilling out of the weld joint. Of course, the present invention includes non-limiting embodiments in which housing assembly 390 is in-line with laser 120 and filler wire 140 and in which housing assembly 390 is located on either the leading edge or training edge of weld puddle 145.

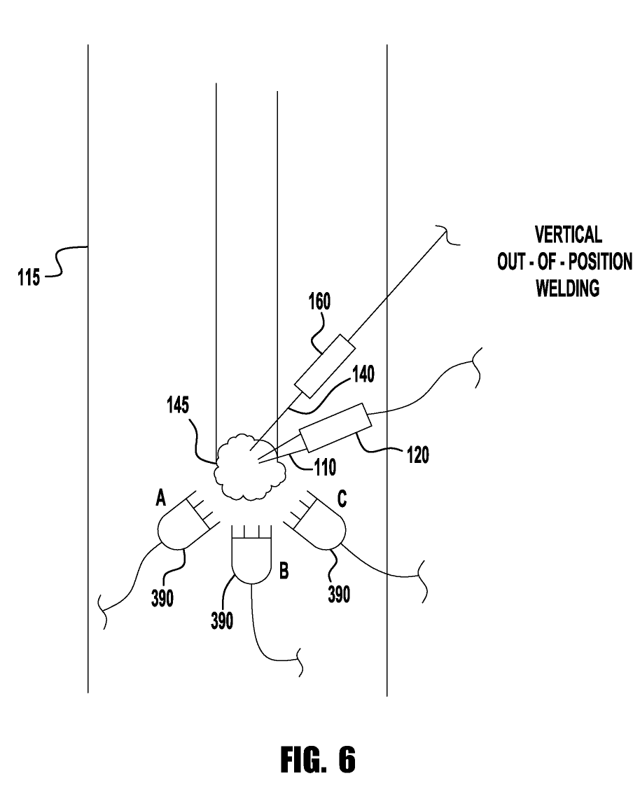

For a vertical out-of-position weld, housing assembly 390 may be located at the bottom. As illustrated in FIG. 6, housing assembly may be located in-line with laser 120 and wire 140 (see position B) or at an angle to laser 120 and wire 140 (see positions A and C). The flow of gas 185 (not shown) is generally directed upward across weld puddle 145 to help prevent the weld puddle 145 from sagging or spilling out of the weld joint. Thus, the direction of the gas flow can be optimized to provide optimum pushing force against the puddle depending on the orientation of the weld. Furthermore, the housing used to deliver the gas 185 can be movable during operation such that the direction of the gas delivery can be changed during operation.

The choice of gas 185 used can vary depending on the application, and may be dependent on the conditions and the types of metals being joined or coated. For example, care must be taken to prevent undesired interactions between the gas 185 and the weld puddle 145 that could affect the quality of the weld. Accordingly, based on the types of metals being welded and the type of filler wire 140 being used, gas 185 may be air, CO₂, nitrogen, any inert gas such as helium or argon, or any combination of the above. Because no arc welding is being utilized, air can be used as many applications do not have the need for the use of traditional shielding gases.

In exemplary embodiments of the invention, gas 185 may be heated to prevent an undesired thermal shock to the weld puddle 145 and/or an undesired cooling of the filler wire 140 prior to its entry into the weld puddle 145. In some exemplary embodiments, the gas is heated to a temperature in the range of 100 to 300° F. Of course other temperatures can be used.

Conversely, the temperature of gas 185 may be selected such that gas 185 provides a cooling effect to weld puddle 145 and thereby forces the weld puddle 145 to solidify faster in order to prevent sagging and spillage. Thus, the gas can be cooled relative to the ambient temperature of the welding/coating application to provide the desired cooling.

During operation, the gas 185 should be provided to the puddle 145 at a pressure which sufficiently holds the puddle in place during the operation. That is, typically, the pressure of the gas will be higher than traditional GMAW or GTAW welding operations because the gas 185 is used to provide a pushing force against the puddle, rather than just shielding. In an exemplary embodiment, the gas 185 is provided to the puddle 145 at a pressure in the range of 15 to 35 psi. That is, the pressure of the gas 185 in the housing assembly 190, 290, 390 is in the range of 15 to 35 psi. In other exemplary embodiments, the pressure is in the range of 20 to 30 psi. Further, in some exemplary embodiments, the pressure can vary depending on the out-of-position orientation of the welding operation. That is, during a welding operation at a first position or orientation the gas is at a first pressure, and when the positioning reaches a second position the gas is provided at a second pressure. For example, if the welding operation is a pipe welding operation, while the welding is at the top of the pipe the pressure could be low, or non-existent because the gravity will keep the puddle in place. However, as the welding operation rotates around the pipe the position becomes more “out-of-position”. Thus, embodiments of the present invention can change the pressure of the gas 185 as the position changes to provide more pressure to hold the puddle in place, where the pressure of the gas 185 is at its highest when welding at the bottom of the pipe. In addition embodiments, the orientation of the gas direction can change depending on the welding position during a welding operation. Thus, in some embodiments not only does the pressure change but the direction of the application of the gas can change. It is noted that the gas “pressure” discussed above is generally understood to be the pressure applied by the gas source, such as through the gas supply valve, etc.

In another exemplary embodiment, the gas 185 can contain a particulate having properties which would enhance the weld. For example the gas 185 can contain a powder which is a corrosion inhibitor that is deposited on the surface of the weld puddle 145 as the puddle solidifies. For example, a corrosion inhibitor such as zinc and zinc compounds can be deposited in powder form with the gas 185. This will provide a protective coating on the resultant weld bead. Of course, particulate having other properties can be used to improve performance characteristics of the weld bead.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed, but that the invention will include all embodiments falling within the scope of the appended claims.

1. A system for using gas flow to control a molten puddle in out-of-position applications, the system comprising:
a high intensity energy source which heats at least one workpiece to create said molten puddle;
a housing assembly which supplies a gas over said molten puddle in order to minimize sagging of said molten puddle in said out-of-position applications; and
a gas source which supplies said gas and is operatively connected to said housing assembly,
wherein a pressure of said gas in said housing assembly is in a range of 15 psi to 35 psi.

2. The system of claim 1, further comprising:
a filler wire feeder which feeds a filler wire to said molten puddle; and
a hot wire power supply which resistance-heats a length of said filler wire to at or near a melting temperature of said filler wire,
wherein an output of said hot wire power supply is controlled such that arcing between said filler wire and said molten puddle is substantially eliminated or minimized.

3. The system of claim 2, wherein said pressure is in a range of 20 psi to 30 psi.

4. The system of claim 1, wherein said high intensity energy source is a laser which directs a laser beam to said at least one workpiece and said housing assembly is operatively connected to said laser.

5. The system of claim 1, wherein said housing assembly comprises at least one guide vane to direct a flow of said gas in a desired direction over said molten puddle.

6. The system of claim 5, wherein said at least one guide vane is disposed in at least one of an interior portion of said housing assembly and a tip of said housing assembly.

7. The system of claim 2, wherein said housing assembly comprises a sheath which accepts said filler wire and isolates said filler wire from said gas as said filler wire is fed to said molten puddle.

8. The system of claim 7, wherein said housing assembly comprises a contact tube which accepts said filler wire and is operatively connected to said sheath.

9. The system of claim 1, wherein said high intensity energy source is a laser which directs a laser beam to said at least one workpiece and said housing assembly passes said laser beam through said housing assembly.

10. The system of claim 1, wherein a particulate is supplied with said gas to enhance a characteristic of a weld formed by said molten puddle.

11. A method of using gas flow to control a molten puddle in out-of-position applications, the method comprising:
heating at least one workpiece to create said molten puddle; and
supplying a gas over said molten puddle in order to minimize sagging of said molten puddle in said out-of-position applications,
wherein said gas is supplied to said molten puddle via a housing assembly, and
wherein a pressure of said gas in said housing assembly is in a range of 15 psi to 35 psi.

12. The method of claim 11, further comprising:
feeding a filler wire to said molten puddle; and
resistance-heating a length of said filler wire to at or near a melting temperature of said filler wire,
wherein said resistance-heating is controlled such that arcing between said filler wire and said molten puddle is substantially eliminated or minimized.

13. The method of claim 12, wherein said pressure is in a range of 20 psi to 30 psi.

14. The method of claim 11, wherein said housing assembly comprises at least one guide vane to direct a flow of said gas in a desired direction over said molten puddle.

15. The method of claim 14, wherein said at least one guide vane is disposed in at least one of an interior portion of said housing assembly and a tip of said housing assembly.

16. The method of claim 11, wherein said housing assembly comprises a sheath which accepts said filler wire and isolates said filler wire from said gas as said filler wire is fed to said molten puddle.

17. The method of claim 16, wherein said housing assembly comprises a contact tube which accepts said filler wire and is operatively connected to said sheath.

18. The method of claim 11, wherein said heating of said at least one workpiece is done using a laser which directs a laser beam to said at least one workpiece and said housing assembly passes said laser beam through said housing assembly.

19. The method of claim 11, wherein said heating of said at least one workpiece is done using a laser which directs a laser beam to said at least one workpiece and said housing assembly is operatively connected to said laser.

20. The method of claim 11, further comprising supplying a particulate with said gas to enhance a characteristic of a weld formed by said molten puddle.
